(19) United States
(12) Patent Application Publication
(10) Pub. No.: US 2018/0198522 A1
(43) Pub. Date: Jul. 12, 2018

(54) OPTICAL TRANSMISSION APPARATUS AND OPTICAL TRANSMISSION METHOD

(71) Applicant: FUJITSU LIMITED, Kawasaki-shi (JP)

(72) Inventors: HIKARI MOCHIZUKI, Fuchu (JP); Taku Saito, Kawasaki (JP)

(73) Assignee: FUJITSU LIMITED, Kawasaki-shi (JP)

(21) Appl. No.: 15/860,338

(22) Filed: Jan. 2, 2018

(30) Foreign Application Priority Data
Jan. 11, 2017 (JP) 2017-002679

(51) Int. Cl. H04B 10/079; H04J 14/02; H04B 10/40

(52) U.S. Cl. CPC H04B 10/07957; H04J 14/021; H04B 10/40; H04J 14/0227

(57) ABSTRACT

An optical transmission apparatus configured to transmit data via a super channel including a plurality of sub channels, the optical transmission apparatus includes a first processor that controls a reference channel from among the plurality of sub channels, in response to a variation component in a frequency of a central wavelength of the super channel; and a second processor that controls a wavelength interval of the sub channels other than the reference channel, based on the reference channel.

### CROSS-REFERENCE TO RELATED APPLICATION

This application is based upon and claims the benefit of priority of the prior Japanese Patent Application No. 2017-002679, filed on Jan. 11, 2017, the entire contents of which are incorporated herein by reference.

### FIELD

The embodiments discussed herein are related to an optical transmission apparatus and an optical transmission method.

### BACKGROUND

In the field of telecommunications, wavelength division multiplex (WDM) is used to increase a data rate and to expand a communications network capability. WDM is a technique of transmitting multiple optical signals different in wavelength using a single optical fiber cable.

In addition to WDM, a super channel technique is used to further increase transmission capacity per optical fiber cable. The super channel (SC) technique multiplexes multiple optical signals in a single frequency domain to transmit the signals. In the SC technique, a modulation scheme such as quadrature amplitude modulation (QAM) is used to multiplex optical signals in a single frequency domain. Each optical signal multiplexed in the SC technique is referred to as a sub channel. The word sub channel is used to represent an optical signal in the frequency domain and time domain. In the SC technique, a frequency bandwidth, such as a 150 GHz band or 162 GHz band, is assigned to accommodate multiple sub channels multiplexed. The multiple sub channels transmitted in this frequency band are collectively referred to as a super channel. In the discussion that follows, the frequency band (wavelength band) is also simply referred to as a band.

In WDM, a sufficient wavelength interval is allowed to control interference between optical signals. For example, if a 100 GHz optical signal is used, the wavelength interval between adjacent optical signals is set to be 50 GHz.

In the SC technique, the mutually adjacent sub channels are close to each other. For this reason, the frequency bandwidths of these sub channels may overlap, and the sub channels may interfere with each other. When the SC technique is used, spectral shaping is performed using a Nyquist filter or the like to narrow the bandwidth of each sub channel to control interference between the adjacent sub channels.

A method is available to control the sub channel interference. In that method, a frequency fluctuation component is set to be a tolerance component in an output light beam from a laser serving as a light source that transmits the sub channels (hereinafter referred to as laser light) and a sub channel interval is thus set up. The frequency of the laser light suffers from fluctuations with time. The sub channel interval is thus set up in view of the fluctuations.

In the method that sets the wavelength interval with a tolerance component allowed, and does not employ the wavelength control described below, it is difficult to accommodate four sub channels within a frequency region of 150 GHz. The width of the frequency region accommodating four sub channels may be 162.5 GHz or more. As a result, the number of channels that an optical fiber cable having a maximum band of 4500 GHz may transmit is 108 at maximum.

The wavelength control method to keep the sub channel interval fixed is disclosed as another method to control the sub channel interference. The wavelength control obviates considering the frequency fluctuations of part of the laser light, the four sub channels are accommodated within the frequency region having a 150 GHz width, and the maximum number of sub channels that are transmitted via the optical fiber cable is 120. In one technique of the wavelength control, one of the four sub channels is set up as a reference (reference channel), and each sub channel other than the reference channel is controlled based on the reference channel. Related-art techniques are disclosed in Japanese Laid-open Patent Publication No. 2014-78915, Japanese Laid-open Patent Publication No. 2014-209685, and Japanese Laid-open Patent Publication No. 2016-10040.

In the wavelength control described above, the reference channel is not handled as a control target. For this reason, the frequency fluctuations of the laser light of the reference channel are not negligible. Concerning the reference channel, a margin is desirable with an adjacent sub channel in the optical transmission ling. The utilization efficiency of the optical transmission line is thus desirable.

### SUMMARY

According to an aspect of the invention, an optical transmission apparatus configured to transmit data via a super channel including a plurality of sub channels, the optical transmission apparatus includes a first processor that controls a reference channel from among the plurality of sub channels, in response to a variation component in a frequency of a central wavelength of the super channel; and a second processor that controls a wavelength interval of the sub channels other than the reference channel, based on the reference channel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an optical transmission system of an embodiment;

FIG. 2 illustrates related-art wavelength control based on wavelength interval;

FIG. 3 is a functional block diagram of each apparatus of the optical transmission system of the embodiment;

FIG. 4 is a sequence chart of a wavelength control process of the embodiment;

FIG. 5 is a functional block diagram of each optical transmission apparatus of the embodiment;

FIG. 6 illustrates a hardware configuration of the optical transmission apparatus of the embodiment;

FIG. 7 illustrates the effect of the wavelength control process of the embodiment; and

FIG. 8 illustrates the effect of the wavelength control process of the embodiment.

### DESCRIPTION OF EMBODIMENT

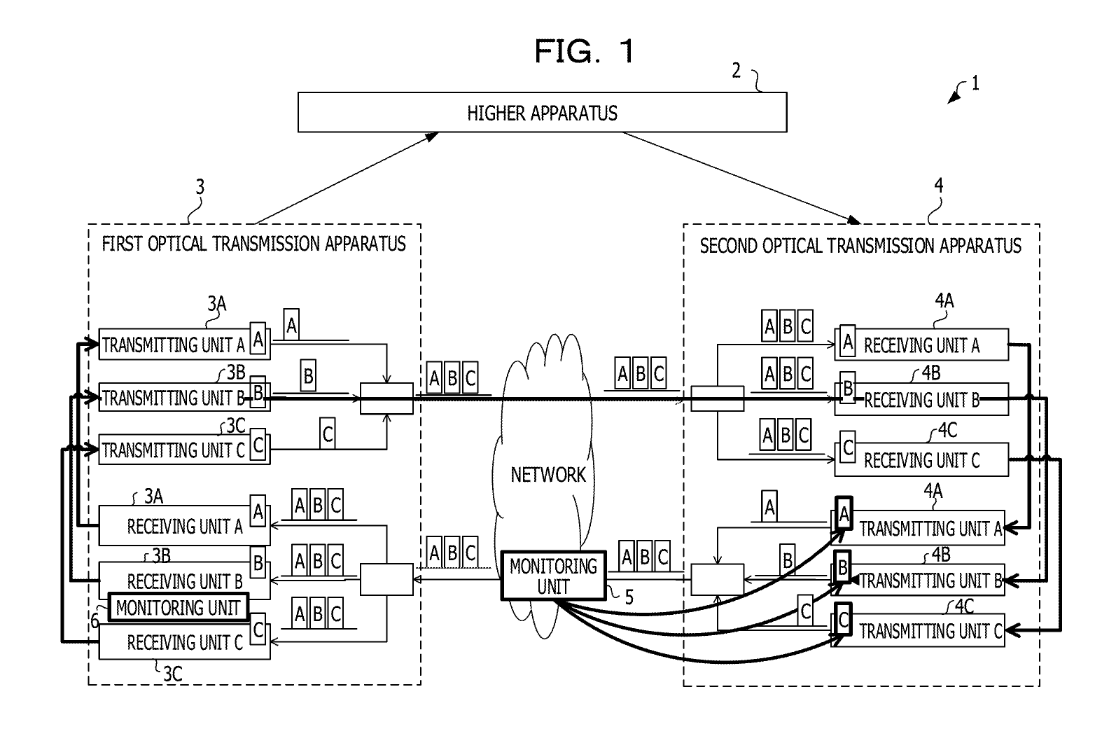

FIG. 1 illustrates an example of an optical transmission system 1 of an embodiment. The optical transmission system 1 includes a higher apparatus 2, a first optical transmission apparatus 3, a second optical transmission apparatus 4, a first monitoring unit 5, and a second monitoring unit 6. In a broad sense, each of the higher apparatus 2 and the first monitoring unit 5 falls within the concept of an optical transmission apparatus.

The first optical transmission apparatus 3 includes a transceiver 3A, a transceiver 3B, and a transceiver 3C. The second optical transmission apparatus 4 includes a transceiver 4A, a transceiver 4B, and a transceiver 4C. Each transceiver has functionalities for transmission and reception. Referring to FIG. 1, a portion for the transmission functionality and a portion for the reception functionality in each transceiver are respectively labeled with a transmitter and a receiver.

The first optical transmission apparatus 3 and the second optical transmission apparatus 4 are connected to each other via an optical transmission line, such as an optical fiber. The first monitoring unit 5 is connected over the optical transmission line extended between the first optical transmission apparatus 3 and the second optical transmission apparatus 4. Referring to FIG. 1, the second monitoring unit 6 is mounted on each of the transceivers 3A, 3B, and 3C in the first optical transmission apparatus 3. The second monitoring unit 6 may be mounted on the transceiver of each of the first and second optical transmission apparatuses 3 and 4 (the transceiver is also referred to as a transponder). The higher apparatus 2 is connected to the transceiver of each of the first and second optical transmission apparatuses 3 and 4, and the first monitoring unit 5 via the optical transmission line, a wired local area network (LAN), a wireless LAN, and the like.

The first optical transmission apparatus 3 includes the transceiver 3A, the transceiver 3B, and the transceiver 3C. The second optical transmission apparatus 4 includes the transceiver 4A, the transceiver 4B, and the transceiver 4C.

The embodiment employs the SC technique, for example. Each of the transceivers 3A, 3B, and 3C transmits or receives sub channels A, B, and C to or from each of the transceivers 4A, 4B, and 4C. The following discussion is based on the assumption that the second optical transmission apparatus 4 transmits the sub channels A, B, and C to the first optical transmission apparatus 3.

In the embodiment, the number of transceivers employed in each of the first optical transmission apparatus 3 and the second optical transmission apparatus 4 is three, for example. The number of sub channels that the transmitter and receiver respectively transmits and receives is three. The embodiment is not limited to three sub channels. For example, there may be a sub channel exchanged between the transceiver 3A and the transceiver 4A. The number of sub channels that the first optical transmission apparatus 3 and the second optical transmission apparatus 4 exchange may be four or more, or two. Another optical transmission apparatus including a transceiver may be employed. The other optical transmission apparatus may be connected to the optical transmission system 1 and exchange another sub channel with the first optical transmission apparatus 3 or the second optical transmission apparatus 4. The number of transceivers mounted on each of the first optical transmission apparatus 3 and the second optical transmission apparatus 4 is not limited to three.

A specific band assigned to accommodate a super channel may be referred to as a super channel band. The super channel band may be a 150 GHz band or 162 GHz band, for example.

In accordance with an example of the embodiment, the sub channel A is adjacent to the sub channel B and the sub channel B is adjacent to the sub channel C. At least one of the sub channels A, B, and C is set to be a reference channel. In accordance with an example of the embodiment, the sub channel B is set to be a reference channel. Alternatively, one of the sub channels A and C may be a reference channel.

Referring to FIG. 1, the first monitoring unit 5 may be mounted over a network of the optical transmission line (hereinafter referred to as an optical network) connecting the first optical transmission apparatus 3 to the second optical transmission apparatus 4. The first monitoring unit 5 includes but is not limited to a reconfigurable optical add-drop multiplexer (ROADM).

In an example of the embodiment, the first monitoring unit 5 has a functionality of an absolute value monitor. The functionality of the absolute value monitor is to monitor the central wavelength of the super channel as an absolute wavelength. In an example of the embodiment, the first monitoring unit 5 detects a frequency fluctuation caused by a time-lapsed change of a laser light source. The first monitoring unit 5 does not necessarily have to have an accuracy level higher than the second monitoring unit 6 that is described below as an absolute value monitor.

The first monitoring unit 5 monitors the central wavelength of the super channel, thereby performing position adjustment in the frequency region of the reference channel. The position adjustment is described in detail below.

The higher apparatus 2 notifies the first monitoring unit 5 of the super channel. The notification may be related to the band of the super channel. The first monitoring unit 5 obtains a spectrum for the sub channels A, B, and C. The spectrum is a value at each frequency (wavelength) component in the frequency region (wavelength region), and is a function of a frequency (wavelength) component.

The first monitoring unit 5 determines the central wavelength of the super channel from the acquired spectrum. The central wavelength of the super channel determined by the first monitoring unit 5 is referred to as a measured value of the central wavelength. The spectrum may be processed, for example, may be smoothed. The first monitoring unit 5 notifies the higher apparatus 2 of the measured value of the determined central wavelength of the super channel.

The higher apparatus 2 calculates a difference between the measured value of the central wavelength of the super channel obtained from the first monitoring unit 5 and an expected value of the central wavelength of the super channel (the difference is also called AX, or a variation component in the central wavelength of the super channel). The expected value of the central wavelength of the super channel refers to the central wavelength in the band of the super channel. The higher apparatus 2 may store the expected value of the central wavelength of the super channel in a table or a relational database, or may store a function to determine the expected value of the central wavelength of the super channel.

Using the difference AX, the higher apparatus 2 determines a wavelength control amount of the reference channel (also referred to as a first wavelength control amount). The wavelength control amount of the super channel is a control amount to control the wavelength of output light from the light source of the sub channels. A method to determine the first wavelength control amount is described below.

The higher apparatus 2 pre-stores information concerning a band to be assigned to the reference channel (the band of the reference channel). For example, the higher apparatus 2 pre-stores the difference AX between the central wavelength of the band of the reference channel and the expected value of the central wavelength of the super channel (hereinafter referred to as Δλ_{center-B}). The higher apparatus 2 may determine the first wavelength control amount, based on the difference Δλ_{center-B} and the difference Δλ.

In an example of the embodiment, the higher apparatus 2 notifies the transceiver 4B of the first wavelength control amount determined. The transceiver 4B performs wavelength control of the sub channel B in accordance with the first wavelength control amount.

The second monitoring unit 6 has a functionality of the absolute value monitor. The functionality of the absolute value monitor is to monitor the wavelength interval between sub channels, and the second monitoring unit 6 is used to regulate the interval between the sub channels. For example, the second monitoring unit 6 is a wavelength interval monitoring unit 705 described below.

In the SC technique, the wavelength interval between sub channels is narrower within the super channel. For this reason, each transceiver may receive part of an adjacent sub channel together with a sub channel that is set to be received by the transceiver (a particular sub channel for the transceiver). The second monitoring unit 6 acquires a spectrum of multiplexed optical signals from the received adjacent sub channel and the particular sub channel. The second monitoring unit 6 then determines the wavelength interval using the spectrum. The second monitoring unit 6 notifies the higher apparatus 2 of the determined wavelength interval.

The wavelength interval determined in an example of the embodiment means the wavelength interval between the sub channel A and sub channel B, and the wavelength interval between the sub channel B and sub channel C. Let Δλ_{AB} represent the wavelength interval between the sub channel A and sub channel B, and Δλ_{BC} represent the wavelength interval between the sub channel B and sub channel C. Each of Δλ_{AB} and Δλ_{BC} may be determined by the second monitoring unit 6 in each of the transceiver 3A and the transceiver 3C. Alternatively, each of Δλ_{AB} and Δλ_{BC} may be determined by the second monitoring unit 6 in the transceiver 3B.

Control of the wavelength interval of each sub channel other than the reference channel with respect to the reference channel (also referred to as wavelength control) is performed between optical transmission apparatuses that are placed at opposed ends. For example, the second monitoring unit 6 in the transceiver 3A with the adjacent interval monitoring functionality thereof detects a deviation in the wavelength of the output light from the transceiver 4A. In order to control the wavelength of the laser light from the laser light source of the transceiver 4A, the transceiver 3A transfers information about a wavelength control amount to the opposed end using the frequency modulation functionality thereof. At the opposed end, the wavelength control amount is extracted from the frequency-modulated optical signal to correct the laser light wavelength.

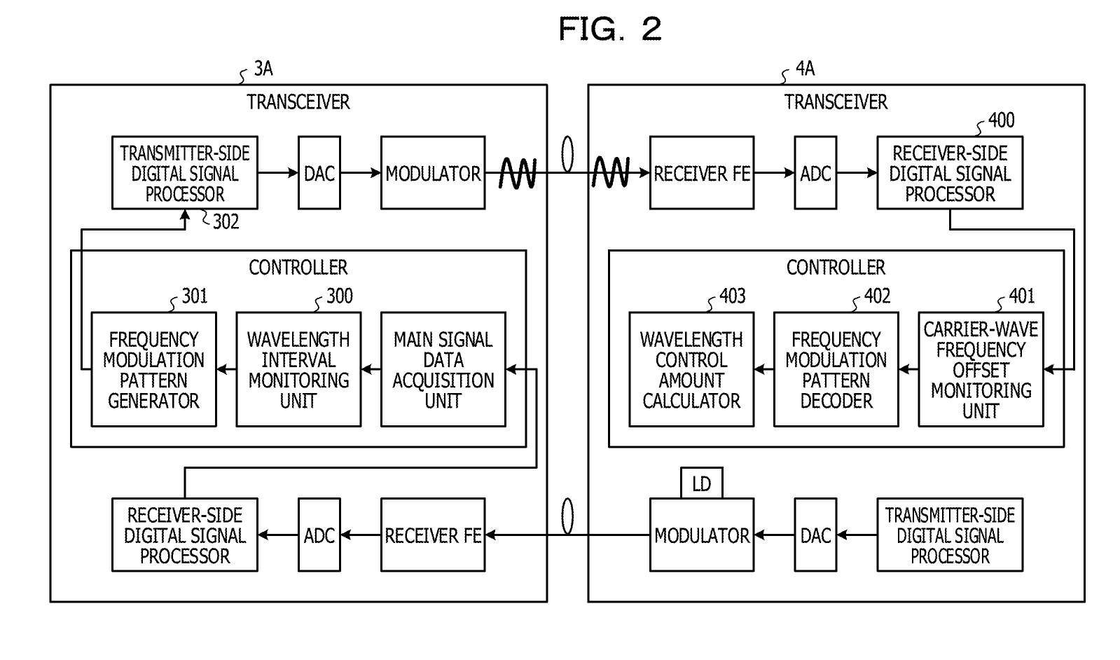

FIG. 2 is a functional block diagram of each transceiver and is used to describe related-art wavelength control in a simple flow chart. In this example, the wavelength control is performed on the laser light from the laser light source of the transceiver 4A. The functionalities of a transmitter-side digital signal processor, a digital-to-analog converter (DAC), a modulator, a laser diode (LD), a receiver front end (FE), an analog-to-digital converter (ADC), a receiver-side digital signal processor, and a main signal data acquisition unit are identical to those of an example of the embodiment described below, and the discussion thereof is omitted herein. Processes other than a process described with reference to FIG. 2 are identical to those described below, and the discussion thereof is omitted herein.

In a way similar to a wavelength interval monitoring unit 705 described below, the wavelength interval monitoring unit 300 of FIG. 2 determines a spectrum from main signal data acquired by the main signal data acquisition unit, and determines the wavelength interval between the sub channel A and another sub channel. Based on the determined wavelength interval, the wavelength interval monitoring unit 300 determines a wavelength control amount of output light from of the LD of the transceiver 4A. The wavelength interval monitoring unit 300 outputs the determined wavelength control amount to a frequency modulation pattern generator 301. The frequency modulation pattern generator 301 accounts for the wavelength control amount in the pattern of the frequency modulation. In accordance with the pattern of the frequency modulation input from the frequency modulation pattern generator 301, a transmitter-side digital signal processor 302 frequency-modulates a transmitter-side digital signal of the main signal. In this way, information related to the wavelength control amount is superimposed on an optical signal directed to the transceiver 4A and then transmitted to the transceiver 4A.

The process of the transceiver 4A is described with reference to FIG. 2. The main signal digitized by the receiver-side digital signal processor 400 is input to a carrier-wave frequency offset monitoring unit 401. The carrier-wave frequency offset monitoring unit 401 monitors whether there is a frequency-modulated main signal. If a frequency modulation pattern is present, the carrier-wave frequency offset monitoring unit 401 outputs the frequency modulation pattern to the frequency modulation pattern decoder 402. The frequency modulation pattern decoder 402 decodes the frequency modulation pattern, and then outputs the decoded frequency modulation pattern to the wavelength control amount calculator 403. The wavelength control amount calculator 403 controls the output light of LD, based on the wavelength control amount responsive to the decoded frequency modulation pattern.

The related-art wavelength control of FIG. 2, namely, the wavelength interval control based on the reference channel, may be performed in cooperation with an apparatus of the embodiment that controls the reference channel using the central wavelength.

In an example of the embodiment, the higher apparatus 2 may acquire information of the wavelength interval acquired by the second monitoring unit 6, and based on the acquired information, control may be performed on the wavelength interval of the sub channel other the reference channel. The embodiment is not limited to this method.

The higher apparatus 2 may acquire the wavelength interval Δλ_{AB} from the first optical transmission apparatus 3, and determine the wavelength control amount of the output light from the light source of the transceiver 4A in accordance with the acquired the wavelength interval Δλ_{AB}. The higher apparatus 2 may acquire a wavelength interval Δλ_{BC} from the first optical transmission apparatus 3, and determine the wavelength control amount of the output light from the light source of the transceiver 4C in accordance with the acquired the wavelength interval Δλ_{BC}. The wavelength control amount of the output light from a light source of a sub channel other the reference channel is referred to as a second wavelength control amount.

The higher apparatus 2 may use the first wavelength control amount together with the wavelength interval Δλ_{AB} to determine the second wavelength control amount of the output light from the light source of the transceiver 4A. The wavelength interval Δλ_{AB} is an interval between the sub channel A and the sub channel B prior to the wavelength control of the reference channel. The higher apparatus 2 may determine, as the second wavelength control amount to be notified to the transceiver 4A, the first wavelength control amount together with the interval between the sub channel A and sub channel B. In this way, the sub channel B may be set to be a reference channel subsequent to the wavelength control.

The higher apparatus 2 determines the second wavelength control amount of the sub channel A, and then notifies the transceiver 4A of the second wavelength control amount.

Similarly, the higher apparatus 2 determines the wavelength control amount of the output light from the light source of the transceiver 4C and notifies the transceiver 4C of the wavelength control amount of the output light from the light source.

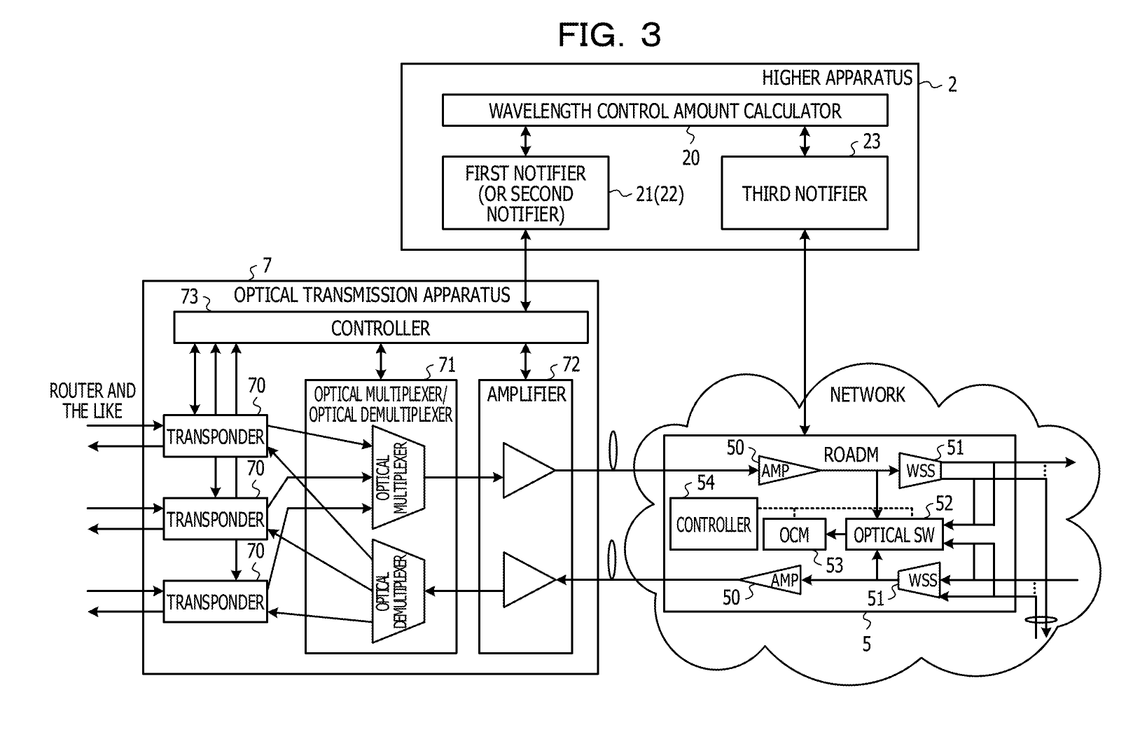

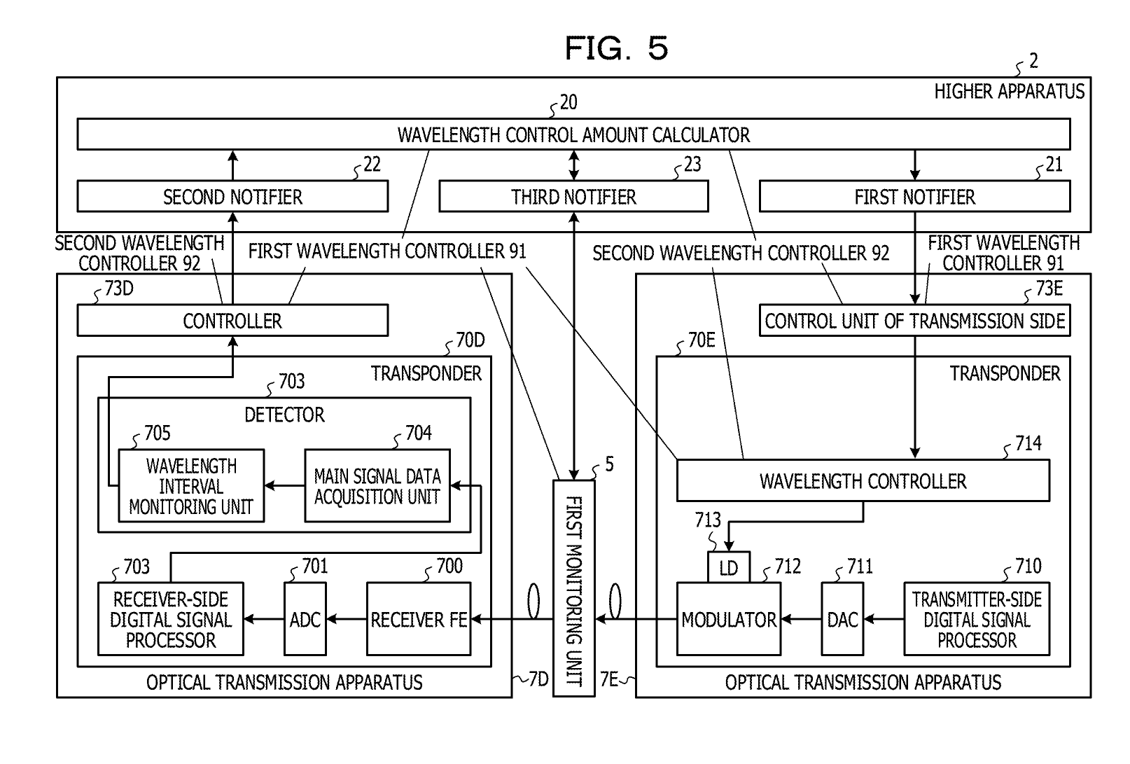

FIG. 3 is a functional block diagram illustrating an optical transmission apparatus 7 (the first optical transmission apparatus 3 or the second optical transmission apparatus 4), the first monitoring unit 5, and the higher apparatus 2 according to an example of the embodiment. A first wavelength controller 91 and a second wavelength controller 92 illustrated in FIG. 5 are respective blocks having functionalities of calculating the first wavelength control amount and the second wavelength control amount. In an example of the embodiment, the wavelength control amount calculator 20 of FIG. 3 has the functionalities of the first wavelength controller 91 and the second wavelength controller 92. The embodiment is not limited to this arrangement. For example, the wavelength control amount calculator 20 may implement the functionality of the first wavelength controller 91 and a controller 73 in the optical transmission apparatus 7 described below may implement the functionality of the second wavelength controller 92. Alternatively, the wavelength control amount calculator 20 may implement the functionality of the first wavelength controller 91 and a wavelength controller 714 in a receiver-side digital signal processor 702 described below may implement the functionality of the second wavelength controller 92. Alternatively, the controller 73 in the optical transmission apparatus 7 may implement the functionalities of the first wavelength controller 91 and the second wavelength controller 92. Alternatively, the first monitoring unit 5 may include a functional block of the first wavelength controller 91.

The optical transmission apparatus 7 may include multiple transponders 70, an optical multiplexer and demultiplexer unit 71, an optical amplifier 72, and a controller 73. The transponder 70 is the transceiver as described above, and is connected to a communication device, such as a router. The optical multiplexer and demultiplexer unit 71 includes a multiplexer (MUX) that multiplexes optical signals input from the multiple transponders 70 and a demultiplexer (DMUX) that demultiplexes an optical signal from the optical network to optical signals directed to the multiple transponders 70. Each multiple transponder 70 is connected to the optical multiplexer and demultiplexer unit 71 via the optical transmission line, such as an optical fiber cable, and exchanges an optical signal with the optical multiplexer and demultiplexer unit 71. The amplifier 72 includes an optical amplifier that amplifies an optical signal traveling from the side of the transponder 70 to the side of the optical network, and an optical amplifier that amplifies an optical signal from the side of the optical network to the side of the transponder 70. The multiplexer of the optical multiplexer and demultiplexer unit 71 and the optical amplifier that amplifies the optical signal traveling to the side of the optical network are connected to each other via the optical network. Similarly, the demultiplexer of the optical multiplexer and demultiplexer unit 71, and the optical amplifier that amplifies the optical signal traveling to the side of the transponder 70 are connected to each other via the optical network.

The controller 73 is connected to each of the transponders 70, the optical multiplexer and demultiplexer unit 71, and the amplifier 72 via control lines. The controller 73 includes communication lines, for example, and performs a communication process with the higher apparatus 2. The controller 73 may include a multi-core processor, a dual-processor, or a single processor. The controller 73 performs operation control on each of the transponders 70, the optical multiplexer and demultiplexer unit 71, and the amplifier 72.

The functional blocks of the first monitoring unit 5 are described below. The first monitoring unit 5 is mounted over the optical network external to the optical transmission apparatus 7, and is thus connected to the optical transmission apparatus 7 via the optical network. In an example of the embodiment, the first monitoring unit 5 is referred to as ROADM 5.

The ROADM 5 includes multiple amplifiers 50, multiple wavelength selective switches (WSS) 51, an optical switch (SW) 52, an optical channel monitor (OCM) 53, and a controller 54. The OCM 53 is also referred to as an acquisition unit. The amplifiers 50 and the WSS 51 are connected to each other via the optical network. The optical SW 52 is connected to the multiple WSS's 51 via an optical transmission line. The optical SW 52 is connected to the OCM 53 via an optical transmission line. The controller 54 is connected to the OCM 53 and the optical SW 52 via control lines.

A combination of an amplifier 50 and a WSS 51 transmits an optical signal in a different direction. For example, the optical signal may be transferred in a direction from the optical transmission apparatus 7 to the optical network side (also referred to as an optical network direction) and in a direction from the optical network side to the optical transmission apparatus 7 (also referred to a local direction). In an example of the embodiment, the combinations of each amplifier 50 and each WSS 51 are two types, one permitting the optical signal to be transferred in the optical network direction or the other permitting the optical signal to be transferred in the local direction. The embodiment is not limited to this arrangement.

The amplifier 50, including a circuit of an optical amplifier, amplifies an input optical signal. The WSS 51 outputs the optical signal multiplexed by WDM to an output port different from band to band. The optical SW 52 performs a branching operation of the optical signal, and a destination switching operation.

The OCM 53 converts an input optical signal into a current, and obtains a spectrum of the optical signal by determining an intensity on each wavelength. The controller 54, including a processor, controls modules including the OCM 53 and the optical SW 52.

The operation of the ROADM 5 is described below. The ROADM 5 receives from the higher apparatus 2 a notification concerning a super channel containing a sub channel serving as a wavelength control target. The notification may be information concerning the band of the super channel.

The optical signal from the optical transmission apparatus 7 is amplified by the amplifier 50 and is then transferred to the WSS 51. All the optical signals transferred to the WSS 51 are branched by the WSS 51 and then input to the optical SW 52. The optical SW 52 selects a super channel as a wavelength control target, based on information concerning the band of the super channel, out of the input optical signals. The OCM 53 acquires the spectrum of the super channel from the optical SW 52, and acquires the measured value of the central wavelength of the super channel. The OCM 53 notifies the higher apparatus 2 of the acquired measured value of the central wavelength of the super channel. The OCM 53 directly notifies the higher apparatus 2 of the acquired measured value. Alternatively, the OCM 53 may transmit the acquired measured value to the higher apparatus 2 via a communication unit (not illustrated).

In an example of the embodiment, the ROADM 5 is illustrated as being separate from the higher apparatus 2. Alternatively, however, the ROADM 5 may be included in the higher apparatus 2 or may be integrated with the third notifier 23 to be discussed below as a unitary module.

The higher apparatus 2 includes the wavelength control amount calculator 20, the first notifier 21, the second notifier 22, and the third notifier 23.

The third notifier 23 notifies the ROADM 5 of the super channel. The notification may be related to the band of the super channel. The information concerning the super channel may be pre-stored on the wavelength control amount calculator 20. In response to the notification of the measured value of the central wavelength of the super channel from the ROADM 5, the third notifier 23 outputs the notification to the wavelength control amount calculator 20.

The second notifier 22 receives the notification of the wavelength interval between the sub channels, and outputs the received wavelength interval between the sub channels to the wavelength control amount calculator 20.

The wavelength control amount calculator 20 having received the measured value of the central wavelength of the super channel determines the difference Δλ between the measured value of the central wavelength of the super channel and the expected value. Based on the difference Δλ, the wavelength control amount calculator 20 determines the first wavelength control amount as the wavelength control amount of the reference channel. The wavelength control amount calculator 20 also determines the second wavelength control amount, based on the wavelength interval between the sub channels received from the second notifier 22. When determining the second wavelength control amount, the wavelength control amount calculator 20 may use the first wavelength control amount together with the wavelength interval between the sub channels. In an example of the embodiment, the first wavelength control amount is the wavelength control amount of the sub channel B. On the other hand, the second wavelength control amounts are a wavelength control amount of the sub channel A with respect to the sub channel B, and a wavelength control amount of the sub channel C with respect to the sub channel B. The wavelength control amount calculator 20 outputs the determined first and second wavelength control amounts to the first notifier 21. The first wavelength control amount is based on the output of the first monitoring unit 5 that operates as an absolute value monitor, and the second wavelength control amount is based on the output of the second monitoring unit 6 that also operates as an absolute value monitor.

In an example of the embodiment, the first notifier 21 notifies the optical transmission apparatus 7 on the transmitter side of the sub channels the first and second wavelength control amounts obtained from the wavelength control amount calculator 20. The wavelength control amount calculator 20 may notify the optical transmission apparatus 7 of the first wavelength control amount and the second wavelength control amount concurrently or separately.

The controller 73 in the optical transmission apparatus 7 outputs the first wavelength control amount to the transponder 70 that transmits the reference channel. Similarly, the controller 73 outputs the second wavelength control amount to the transponder 70 that transmits the sub channels other than the reference channel. In an example of the embodiment, the first wavelength control amount is output to the transceiver 4B. The wavelength control amount of the sub channel A, out of the second wavelength control amount, is output to the transceiver 4A. The wavelength control amount of the sub channel C, out of the second wavelength control amount, is output to the transceiver 4C.

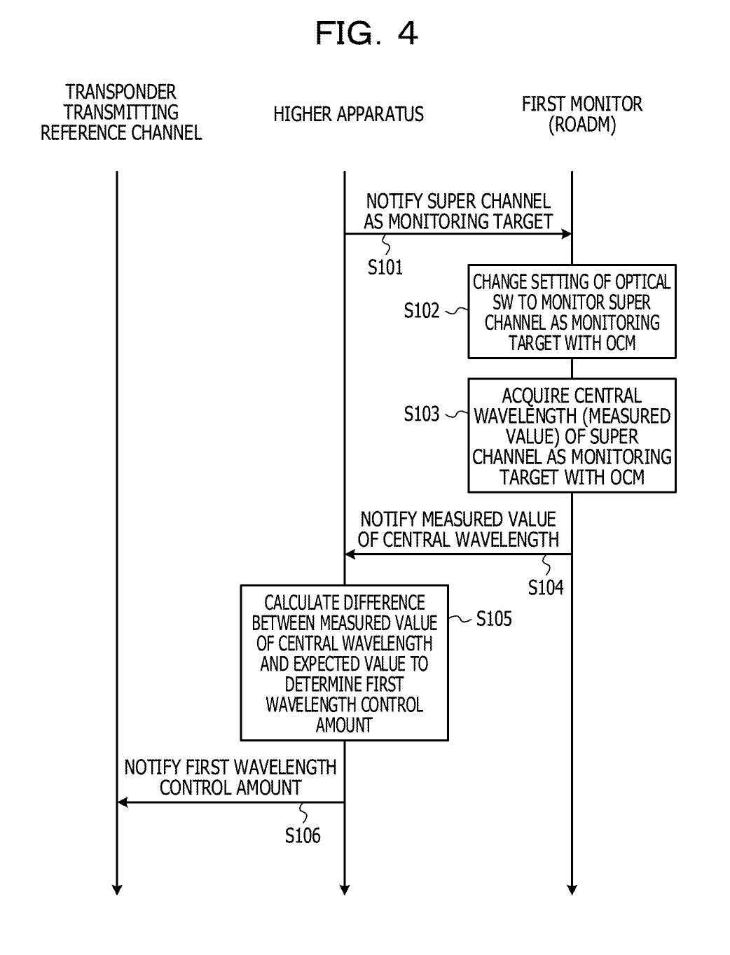

The wavelength control of the sub channel B is described with reference to a flowchart of FIG. 4. Referring to FIG. 4, via the third notifier 23, the higher apparatus 2 notifies the ROADM 5 of the super channel serving as a wavelength control target (S101). The notification of the sub channel C may be a notification of the band of the super channel. In accordance with the embodiment, the band of the super channel is notified. The ROADM 5 switches the setting of the optical SW 52 (S102). In order to monitor the super channel in the band of the notified super channel, the first monitoring unit 5 may switch the setting of the optical SW 52. The OCM 53 measures the central wavelength of the super channel serving as a monitor target (S103). The ROADM 5 notifies the higher apparatus 2 of the measured value of the central wavelength of the determined super channel (S104). As described above, the ROADM 5 determines the measured value of the central wavelength of the super channel and then notifies the higher apparatus 2 of the measured value of the central wavelength. Alternatively, however, the higher apparatus 2 may periodically request the ROADM 5 to send a response as to whether the measured value of the central wavelength of the determined super channel is present or not.

The wavelength control amount calculator 20 in the higher apparatus 2 calculates a difference between the measured value of the central wavelength of the super channel acquired from the ROADM 5 via the third notifier 23 and the expected value of the central wavelength of the super channel stored on the wavelength control amount calculator 20 (S105). The higher apparatus 2 transfers the first wavelength control amount based on the determined difference from the first notifier 21 to the controller 73 with a destination set to be the transponder 70 that transmits the reference channel or the transceiver 4B as an example of the embodiment (S106).

The wavelength control amount calculator 20 obtains the wavelength interval between the sub channels, determines the second wavelength control amount from the wavelength interval, and notifies the determined second wavelength control amount from the first notifier 21 to the controller 73 in the optical transmission apparatus 7. In an example of the embodiment, the higher apparatus 2 notifies the wavelength control amount of the sub channel A out of the second wavelength control amounts to the controller 73 in the second optical transmission apparatus 4 with a destination thereof set to be the transceiver 4A. Similarly, the higher apparatus 2 notifies the wavelength control amount of the sub channel C out of the second wavelength control amounts to the controller 73 in the second optical transmission apparatus 4 with a destination thereof set to be the transceiver 4C.

In the discussion that follows, the transceiver having the second monitoring unit 6 is referred to as a transponder 70D, and the transceiver that transmits a sub channel to the transponder 70D is referred to as a transponder 70E. Described with reference to FIG. 5 are an operation to acquire the wavelength interval, an operation to calculate the second wavelength control amount, an operation of the higher apparatus 2 to notify the transponder 70E of the second wavelength control amount, and a wavelength control operation of the transponder 70E which has received the second wavelength control amount.

The transponder 70D includes a receiver front end (FE) 700, an analog-to-digital converter (ADC) 701, a receiver-side digital signal processor 702, and a detector 703. The receiver FE 700 is connected to the ADC 701 via a signal line. The ADC 701 and the receiver-side digital signal processor 702 are connected to each other via a control line, and the receiver-side digital signal processor 702 and the detector 703 are connected to each other via a control line. The detector 703 includes a main signal data acquisition unit 704 and a wavelength interval monitoring unit 705 mutually connected to each other via a control line. The wavelength interval monitoring unit 705 is connected via a control line to the controller 73 (referred to as a controller 73D) in the optical transmission apparatus 7 including the transponder 70D.

The transponder 70E includes a transmitter-side digital signal processor 710, a DAC 711, a modulator 712, a laser diode (LD) 713, and a wavelength controller 714. The transmitter-side digital signal processor 710 and the DAC 711 are connected to each other via a signal line. The DAC 711 and the modulator 712 are connected to each other via a signal line. The LD 713 and the wavelength controller 714 are connected to each other via a control line. The wavelength controller 714 is connected via a control line to the controller 73 (referred to as a controller 73E) in the optical transmission apparatus 7 including the transponder 70E.

The elements of the transponder 70D are illustrated in an example of the embodiment to describe the functionalities related to reception and acquisition of the wavelength interval. The transponder 70D may include each element of the transponder 70E. Conversely, the transponder 70E may include each element of the transponder 70D. The transceiver 3B may include the elements of the transponder 70D, and the transceiver 4B may include the elements of the transponder 70E.

A sub channel transmission and reception process and a wavelength control process performed between each of the transponder 70D and the transponder 70E and the higher apparatus 2 are described below. FIG. 5 illustrates functional blocks of the transponders 70D and 70E, and procedures of the processes. The hardware configuration of the transponders 70D and 70E that implements the functionalities of the transponders 70D and 70E is described below. An example of the hardware configuration of the optical transmission apparatus 7 includes the hardware configuration of the elements other than the transponder 70 and the hardware configuration of the transponders 70D and 70E.

The transponders 70D and 70E are described in detail with reference to FIG. 5. The transmitter-side digital signal processor 710 in the transponder 70E generates a digital signal for transmission that has been spectral-shaped (referred to as a transmission digital signal), and outputs the generated transmission digital signal to the DAC 711. The transmitter-side digital signal processor 710 includes a multi-core processor, a dual-processor, or a single processor, and also includes a filter for spectral shaping.

The DAC 711 converts the acquired transmission digital signal into an analog signal (also referred to as an analog driving signal), and outputs the analog driving signal to the modulator 712. The modulator 712 modulates output light from the LD 713 with the input analog driving signal, and transmits an optical signal obtained as a result of modulation to the transponder 70D.

The receiver FE 700 in the transponder 70D receives the optical signal via the optical network. The receiver FE 700 includes a photoelectric converting circuit to convert the optical signal into an analog electrical signal. The receiver FE 700 outputs the generated analog electrical signal to the ADC 701. The receiver FE 700 may be implemented using an optical communication interface.

The ADC 701 converts the analog electrical signal obtained from the receiver FE 700 into a digital electrical signal. The ADC 701 outputs the digital electrical signal to the receiver-side digital signal processor 702.

The receiver-side digital signal processor 702 includes a tunable optical dispersion compensator, for example. The receiver-side digital signal processor 702 performs a wavelength dispersion process on the digital electric signal input from the ADC 701, and inputs the resulting digital signal to the main signal data acquisition unit 704 in the detector 703. The functionalities of the receiver-side digital signal processor 702, the main signal data acquisition unit 704, and the wavelength interval monitoring unit 705 may be implemented by a digital signal processor (DSP), or a field programmable gate array (FPGA).

The main signal data acquisition unit 704 acquires the main signal data having a data length sufficient to detect the wavelength interval, from the digital data input from the receiver-side digital signal processor 702.

The wavelength interval monitoring unit 705 performs fast Fourier transform (FFT) analysis on the main signal data acquired by the main signal data acquisition unit 704, thereby determining a spectrum from the main signal data. The spectrum resulting from FFT includes a spectrum corresponding to a sub channel from the transponder 70E (referred to as a sub channel E or a channel of the transponder 70E) and a spectrum of a sub channel adjacent to the sub channel E (hereinafter referred to as an adjacent channel). The wavelength interval monitoring unit 705 determines the wavelength intervals of these sub channels from the acquired spectrum. The method of determining the wavelength interval is a related-art technique, and the discussion thereof is emitted herein.

The wavelength interval monitoring unit 705 outputs the determined wavelength interval to the controller 73D. The controller 73D notifies the second notifier 22 in the higher apparatus 2 of the wavelength interval.

The second notifier 22 in the higher apparatus 2 having received the wavelength interval from the transponder 70D outputs the wavelength interval to the wavelength control amount calculator 20. Using the notified wavelength interval, the wavelength control amount calculator 20 determines the second wavelength control amount of the sub channel from the transponder 70E. As previously described, the first wavelength control amount may be used. The determined second wavelength control amount is output from the wavelength control amount calculator 20 to the first notifier 21. The first notifier 21 in the higher apparatus 2 notifies the controller 73E in the optical transmission apparatus 7 including the transponder 70E of the second wavelength control amount.

The controller 73E outputs the second wavelength control amount received from the higher apparatus 2 to the wavelength controller 714 in the transponder 70E. The wavelength controller 714 controls the wavelength of the output light from the LD 713 in response to the second wavelength control amount. The wavelength controller 714 may receive the notification of the first wavelength control amount from the higher apparatus 2, and control the wavelength of the output light from the LD 713 using the first and second wavelength control amounts.

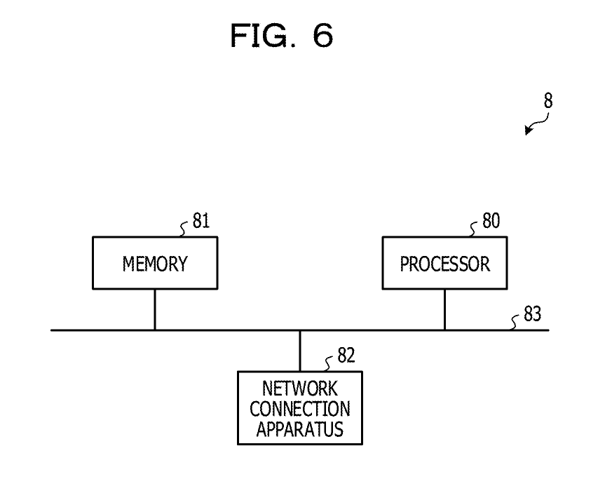

FIG. 6 illustrates a hardware configuration of the optical transmission apparatus 2 of the embodiment. The functionalities of the higher apparatus 2 illustrated in FIG. 3 and FIG. 5 may be implemented by an information processing apparatus 8 of FIG. 6.

The information processing apparatus 8 of FIG. 6 includes a processor 80, a memory 81, and a network connection apparatus 82. These elements are connected via a bus 83.

The processor 80 includes a single-core processor, a multi-core processor, or the like.

The memory 81 may be a read-only memory (ROM), a random-access memory (RAM), or a semiconductor memory.

The processor 80 executes a variety of programs stored on the memory 81, thereby performing the processes described above. The processor 80 and the memory 81 implement the functionalities of the wavelength control amount calculator 20.

The information processing apparatus 8 may include a storage device (not illustrated). Data and programs used in a wavelength control amount calculation process may be stored on the storage device. The memory 81 may read the data and programs from the storage device, and perform the wavelength control amount calculation process. The storage device may be a portable recording medium.

The network connection apparatus 82 is a communication interface that is connected to a communication network, such as an optical transmission line, or wired or wireless LAN, and performs data conversion or data transfer in communications. The network connection apparatus 82 implements the functionalities of the first notifier 21, the second notifier 22, and the third notifier 23.

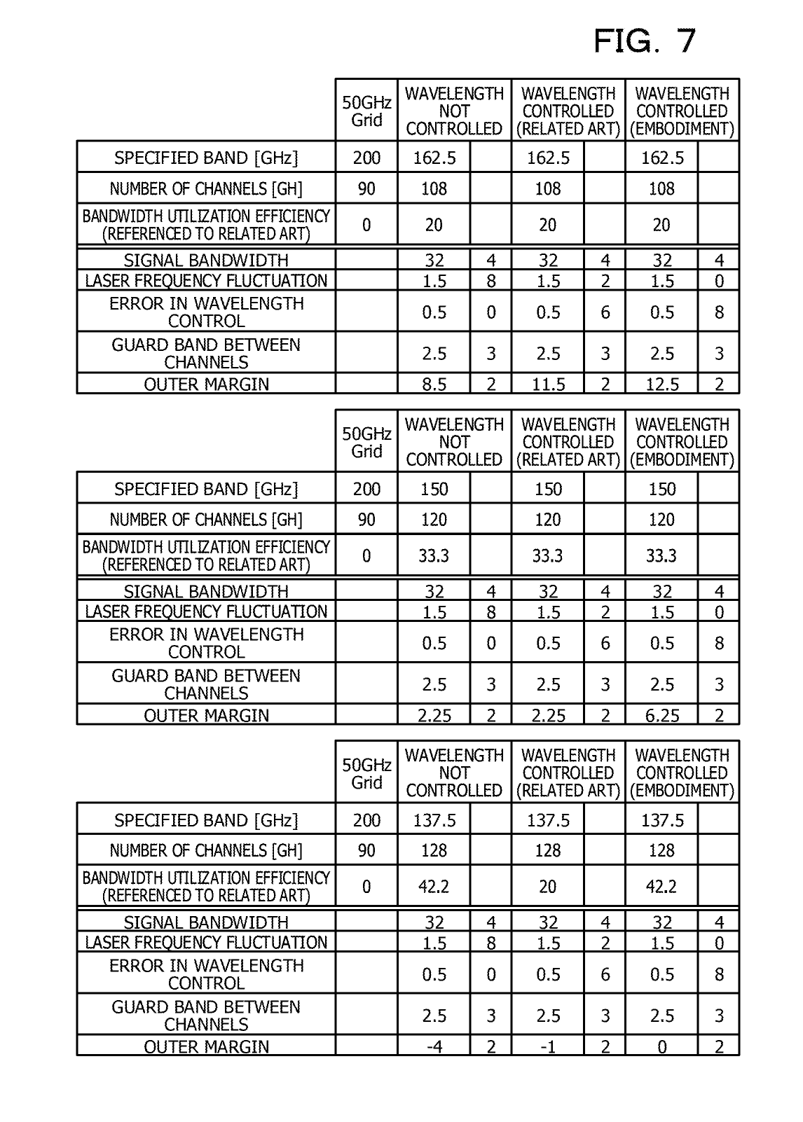

FIG. 7 described how different the band utilization efficiency of the optical transmission line is from the band utilization efficiency in related art if the wavelength control of the embodiment is performed. FIG. 7 illustrates three tables. In each table, the whole bandwidth of the optical transmission line is 4500 GHz. In the first data column from right in each table, the wavelength interval is 50 GHz with the SC technique not used. The first data column is displayed in comparison with second to fourth data columns. The data obtained and listed in the second to fourth data columns is displayed with the SC technique used. The second data column lists data with the wavelength control not used. The third data column lists data that is obtained with the wavelength control performed on sub channels other than the reference channel and no wavelength control performed on the reference channel. The fourth data column lists data that is obtained with the wavelength control of the embodiment performed.

The first data row in each table lists a specified band that accommodates four optical signals. If the SC technique is not used, the specified band is 200 GHz as listed at the first data row and the first data column in each table. In the upper table of FIG. 7, the second data column through the fourth data column at the first data row indicate that the four sub channels are accommodated in a band of 162.5 GHz. Similarly, in the middle table of FIG. 7, the second data column through the fourth data column at the first data row indicate that the four sub channels are accommodated in a band of 150 GHz if the SC technique is used. In the lower table of FIG. 7, the second data column through the fourth data column at the first data row indicate that the four sub channels are accommodated in a band of 137.5 GHz if the SC technique is used.

The second data row in each table indicates the number of channels accommodated in the optical transmission line having a bandwidth of 4500 GHz. In each table, the second data row and the first data column indicate that 90 bands of 50 GHz optical signal are accommodated in 4500 GHz. In the table of FIG. 4A, each of the second through fourth data columns at the second data row indicates the number of sub channels accommodated in 4500 GHz, namely, 108 if the four sub channels are grouped as a super channel. In the table of FIG. 4B, each of the second through fourth data columns at the second data row indicates the number of sub channels accommodated in the whole band, namely, 120 if the four sub channels are grouped as a super channel. Similarly, in the table of FIG. 4C, each of the second through fourth data columns at the second data row indicates the number of sub channels accommodated in the whole band, namely, 128 if the four sub channels are grouped as a super channel.

The third data row in each table indicates, as a band utilization efficiency, a rate of increase in percentage on the upper-limit of the accommodatable number of sub channels with reference to an upper-limit of 90 on the number of bands of optical signals accommodated in the whole band for the optical transmission line when the SC technique is not used. For example, in the upper table of FIG. 7, each of the second through the fourth data columns at the third data row indicates that the use of the SC technique increases the band utilization efficiency by 1.2 times. Similarly, the middle and lower tables of FIG. 7 indicate that the use of the SC technique increases the band utilization efficiency by 33.3% and 42.2%, respectively.

The eighth data row in each table is now considered. The eighth data row indicates an outer margin of the specified band. The outer margin refers to an outer portion of the band of the super channel, and accommodates no sub channels, and thus serves as a margin. With the outer margin ensured, the super channel is transmitted.

In the upper table of FIG. 7, the eighth data row and the fourth data column indicates the outer margin when the wavelength control of the embodiment is performed. The outer margin indicated there is 12.5 GHz. This value is wider than the bandwidth of 8.5 GHz of the outer margin with no wavelength control performed indicated at the eighth data row and the second data column. Similarly, this value is wider than the bandwidth of 11.5 GHz of the outer margin with no wavelength control performed on the reference channel indicated at the third data column. This indicates that the wavelength control of the example of the embodiment results in an outer margin wider than related art techniques. With the outer margin expanded more, the transmission distance of each sub channel in the super channel extends more.

In view of the eighth data row in the middle table of FIG. 7, a bandwidth of 6.25 GHz at the fourth data column with the wavelength control of the example of the embodiment performed is wider than 2.25 GHz at the second data column, and 5.25 GHz at the third column. This is interpreted that the wavelength control of the example of the embodiment performed on the specified band of 150 GHz extends the transmission range of each sub channel in the super channel.

In view of the eighth data row in the lower table of FIG. 7, the width of the outer margin is a negative value at each of the second and third data columns. The negative value at the second data column means that the transmission of the super channel is difficult. The negative value at the third data column also means that the transmission of the super channel is difficult. On the other hand, the wavelength control of the example of the embodiment results in an outer margin of 0 GHz at the fourth data column. In this way, if the wavelength control of the example of the embodiment is used, the transmission of a super channel having a band of 137.5 GHz is possible. As illustrated in the third data column, the band utilization efficiency is increased by 42.2%, meaning that the band of the optical transmission line is more effectively used than the specified band of 150 GHz or 162.5 GHz.

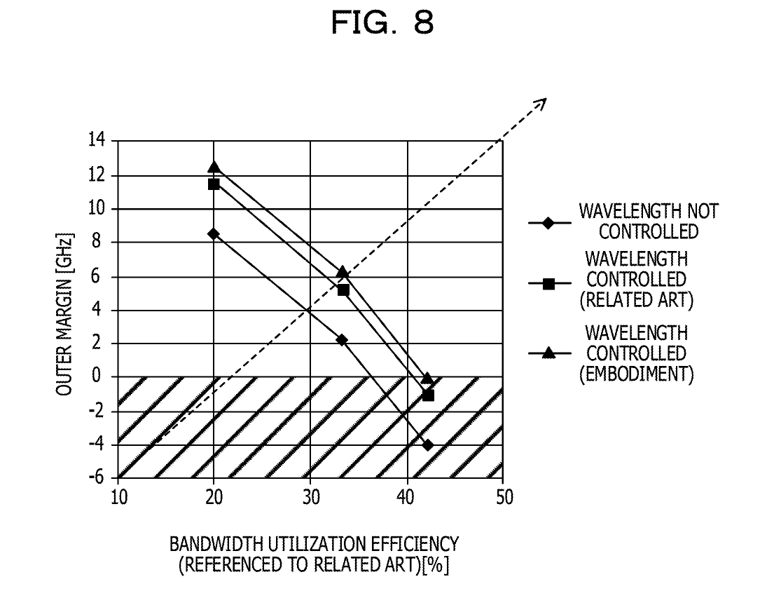

FIG. 8 illustrates points corresponding to data in the three tables of FIG. 7 with the abscissa representing the band utilization efficiency and the ordinate representing the outer margin. Referring to FIG. 8, diamonds represent the band utilization efficiency and outer margin listed in the second data columns of the tables when no wavelength control is performed. Squares represent the band utilization efficiency and outer margin listed in the third data columns of the tables when no wavelength control is performed on the reference channel. Triangles represent the band utilization efficiency and outer margin listed in the fourth data columns of the tables when the wavelength control of the example of the embodiment is performed. If the three diamonds are connected, the three squares are connected, and the three triangles are connected, the lines connected by the three triangles are located in a more upper-right portion than other lines. This means that if the wavelength control of the example of the embodiment is performed, the band utilization efficiency is higher, and the transmission range is longer because of a wider outer margin.

A hatched area illustrated in FIG. 8 is a portion where the transmission of an optical signal is difficult. Referring to FIG. 8, there are cases in which the transmission of the super channel is possible if the wavelength control of the example of the embodiment is performed while the transmission of the super channel is difficult without the wavelength control of the example of the embodiment.

As described above, the wavelength control is performed on the reference channel in an example of the embodiment. In this way, a margin corresponding to the frequency fluctuation of the output light is reduced between channels. Even if multiple sub channels are accommodated within a band narrower than a band in the related art, the transmission of the sub channels is still possible. More sub channels are thus accommodated in the band of the optical transmission line. The utilization efficiency of the band of the optical transmission line is thus increased. In other words, since a margin accounting for the frequency fluctuations of the laser light does not necessarily have to be used, the frequency utilization efficiency is increased.

### Other Embodiments

In the embodiment described above, the higher apparatus 2 determines the first wavelength control amount and the second wavelength control amount. Alternatively, however, the functionality of the higher apparatus 2 may be transferred to the controller 73 in the optical transmission apparatus 7, and the controller 73 may determine the first wavelength control amount and the second wavelength control amount. For example, the controller 73 may perform the functionality of the first wavelength controller 91 and the functionality of the second wavelength controller 92 illustrated in FIG. 3 and FIG. 5.

The controller 73 in at least one of the optical transmission apparatus 7 having the transponder 70D and the optical transmission apparatus 7 having the transponder 70E may notify the ROADM 5 of the super channel. If the controller 73D performs the functionalities of the first wavelength controller 91 and the second wavelength controller 92, and the functionality of the higher apparatus 2, the controller 73D may include the functional blocks corresponding to the first notifier 21 and the third notifier 23.

The controller 73E may implement the functionality of the first wavelength controller 91. In such a case, the controller 73E may implement the functionality of the third notifier 23, may notify the ROADM 5 of the super channel, and may receive the notification of the measured value of the central wavelength of the super channel from the ROADM 5. The controller 73E may determine the wavelength control amount. The controller 73E may include a functional block that has a functionality to directly notify the wavelength control amount to the transponder as a functionality corresponding to the functionality of the first notifier 21. The controller 73E may include a functional block that implements the functionality of the second wavelength controller 92 and the second notifier 22, receive the notification of the wavelength interval from the controller 73D in the transponder 70D, and determine the second wavelength control amount.

The transponder 70D may include a functional block that implements the functionalities of the first wavelength controller 91, the second wavelength controller 92, and the first notifier 21, and the controller 73D may include a functional block that implements the functionality of the third notifier 23. In such a case, the transponder 70D may superimpose the wavelength control amount determined by the controller 73D on the main signal through frequency modulation, and then notifies the controller 73E of the wavelength control amount.

The controller 54 in the ROADM 5 may have the functionality of the first wavelength controller 91, and determine the first wavelength control amount.

The elements that determine the first wavelength control amount and the second wavelength control amount are not limited to those described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission apparatus configured to transmit data via a super channel including a plurality of sub channels, the optical transmission apparatus comprising:
a first processor that controls a reference channel from among the plurality of sub channels, in response to a variation component in a frequency of a central wavelength of the super channel; and
a second processor that controls a wavelength interval of the sub channels other than the reference channel, based on the reference channel.

2. The optical transmission apparatus according to claim 1, further comprises
a first monitor that acquires a measured value of the central wavelength of the super channel,
wherein the first processor is configured to:
receive a notification of the measured value of the central wavelength of the super channel, and
control the reference channel in response to the variation component in the frequency of the central wavelength, with the variation component based on the measured value and an expected value of the central wavelength of the super channel.

3. The optical transmission apparatus according to claim 2, further comprises
a higher apparatus that controls the optical transmission apparatus,
wherein the first monitor is configured to
transmit the acquired measured value to the higher apparatus,
wherein the higher apparatus is configured to:
calculate a difference between the acquired measured value and the expected value of the central wavelength of the super channel,
calculate, using the calculated difference, a first control amount to control the reference channel, and
transmit the calculated first control amount to the optical transmission apparatus, and
wherein the first processor is configured to
control the reference channel, based on the calculated first control amount.

4. The optical transmission apparatus according to claim 1,
wherein the first monitor is located over a transmission line of the super channel.

5. The optical transmission apparatus according to claim 1,
wherein the first monitor is a reconfigurable optical add-drop multiplexer.

6. The optical transmission apparatus according to claim 1, further comprising
a second monitor that acquires a wavelength interval between the plurality of sub channels in the super channel,
wherein the second processor is configured to control the wavelength interval of the plurality of sub channels other than the reference channel in the plurality of sub channels, based on the acquired wavelength interval.

7. The optical transmission apparatus according to claim 5,
wherein the second monitor is configured to
transmit the acquired wavelength interval to the higher apparatus,
wherein the higher apparatus is configured to:
calculate a second control amount of the plurality of sub channels other than the reference channel, based on the acquired wavelength interval, and
transmit the calculated second control amount to the optical transmission apparatus, and
wherein the second processor is configured to
control the wavelength interval of the plurality of sub channels other than the reference channel, based on the calculated second control amount.

8. An optical transmission method executed by an optical transmission apparatus configured to transmit data via a super channel including a plurality of sub channels, the optical transmission method comprising:
controlling, by a first processor, a reference channel from among a plurality of sub channels, in response to a variation component in a frequency of a central wavelength of a super channel: and
controlling, by a second processor, a wavelength interval of the plurality of sub channels other than the reference channel, based on the reference channel.

9. The optical transmission method according to claim 8, further comprises
receiving, by the first processor, a notification of a value of the central wavelength of the super channel acquired by a first monitor,
wherein the controlling the reference channel includes controlling the reference channel in response to the variation component in the frequency of the central wavelength, with the variation component based on the value and an expected value of the central wavelength of the super channel.

10. The optical transmission method according to claim 9,
wherein the first monitor is located over a transmission line of the super channel.

11. The optical transmission method according to claim 9,
wherein the first monitor is a reconfigurable optical add-drop multiplexer.

12. The optical transmission method according to claim 9, further comprises
receiving, by the second processor, a wavelength interval between the plurality of sub channels in the super channel acquired by a second monitor,
wherein the controlling the wavelength interval includes controlling the wavelength interval based on the received wavelength interval.
